(19) United States
(12) Patent Application Publication
(10) Pub. No.: US 2022/0325471 A1
(43) Pub. Date: Oct. 13, 2022

(54) Fabric Processing Method, Processed Fabric, Textile Printing Method, And Composition Set

(71) Applicant: Seiko Epson Corporation, Tokyo (JP)

(72) Inventor: Takayoshi KAGATA, Shiojiri (JP)

(21) Appl. No.: 17/708,308

(22) Filed: Mar. 30, 2022

(30) Foreign Application Priority Data
Mar. 31, 2021 (JP) 2021-059707

(51) Int. Cl. D06P 5/30; B41J 3/407; C09D 11/328; D06P 5/20; D06P 5/15

(52) U.S. Cl. CPC D06P 5/30; B41J 3/4078; C09D 11/328; D06P 5/2077; D06P 5/151

(57) ABSTRACT

A fabric processing method of the present disclosure includes an attaching step of attaching a carboxylic anhydride to a fabric containing cellulose, and an esterification step of esterifying a hydroxyl group of the cellulose, in which, in the esterification step, the carboxylic acid is introduced into the cellulose through an ester bond. A molecular weight of the carboxylic anhydride preferably is 1000 or less.

The present application is based on, and claims priority from JP Application Serial Number 2021-059707, filed Mar. 31, 2021, the disclosure of which is hereby incorporated by reference herein in its entirety.

### BACKGROUND

### 1. Technical Field

The present disclosure relates to a fabric processing method, a processed fabric, a textile printing method, and a composition set.

### 2. Related Art

In recent years, ink jet printing applications have expanded and, in addition to printing machines for office and home use, there have also been applications to commercial printing, textile printing, and the like.

Ink jet inks including sublimable dyes having a sublimation property and disperse dyes are also used.

For these ink jet inks, there are direct printing methods, in which dyeing is carried out with a dye by a heating process such as steaming after the ink is applied to a fabric to be dyed, and thermal transfer printing methods, in which a dye ink is applied to an intermediate transfer medium and then, by heating, the dye is transferred by sublimation from the intermediate transfer medium side to a fabric to be dyed.

However, in the related art, when dyeing with an ink jet ink, it was necessary for the fabric to be formed of polyester fiber.

In order to perform high quality textile printing on recording sheets of various materials other than polyester, a textile printing method using ink jet textile printing ink containing colored particles including disperse dyes and polyester resin was proposed (refer to JP-A-2019-182941).

However, there were cases where the method described above did not obtain sufficient color development.

### SUMMARY

The present disclosure can be realized in the following aspects or application examples.

A fabric processing method according to an application example of the present disclosure includes an attaching step of attaching a carboxylic anhydride to a fabric containing cellulose, and an esterification step of esterifying a hydroxyl group of the cellulose, in which, in the esterification step, carboxylic acid is introduced into the cellulose through an ester bond.

A processed fabric according to an application example of the present disclosure is obtained by the fabric processing method according to an application example of the present disclosure.

A textile printing method according to an application example of the present disclosure includes an ink composition attaching step of applying an ink jet dye textile printing ink composition containing a dye and water to an intermediate transfer medium by an ink jet method to form an image, and a transfer step of heating the intermediate transfer medium and a processed fabric, which is obtained by a fabric processing method according to an application example of the present disclosure, in a state where the intermediate transfer medium and the processed fabric face each other such that the image is transferred to the processed fabric.

A composition set according to an application example of the present disclosure includes a carboxylic anhydride-containing composition including a carboxylic anhydride, and an ink jet dye textile printing ink composition containing a dye and water.

### DESCRIPTION OF EXEMPLARY EMBODIMENTS

A detailed description will be given below of suitable embodiments of the present disclosure.

### 1. Fabric Processing Method

First, a description will be given of the fabric processing method of the present disclosure.

The fabric processing method of the present disclosure has an attaching step of attaching a carboxylic anhydride to a fabric containing cellulose, and an esterification step of esterifying a hydroxyl group of the cellulose. In the esterification step, carboxylic acid is introduced into the cellulose through an ester bond.

In this manner, by reacting a hydroxyl group included in the cellulose fiber forming the fabric with a carboxylic anhydride and introducing a carboxylic acid corresponding to the carboxylic anhydride into the cellulose, in particular, introducing an organic group corresponding to the carboxylic anhydride by a covalent bond with a strong bonding force through an ester bond, the hydrophilicity of the fabric is reduced, and in general, the affinity for dyes with low hydrophilicity is improved, the dyeability of the dye is improved, and the color development is also excellent. In addition, since the organic group is introduced by covalent bonds with a strong bonding force, the dyed product obtained by textile printing has excellent fastness. In addition, it is possible to suitably use the processed fabric obtained by such a fabric processing method for the manufacturing of dyed products with excellent texture.

### 1-1. Attaching Step

In the attaching step, a carboxylic anhydride is attached to a fabric containing cellulose.

### 1-1-1. Fabric

A description will be given below of the fabric for the attaching step.

The fabric may be any fabric which includes cellulose fibers. Examples of such fibers include semi-synthetic fibers such as acetate fibers, regenerated fibers such as rayon, and natural fibers such as cotton, silk, wool, and the like and the fabric may be a blend using two or more selected from the above. In addition, blends of cellulose fibers and fibers other than cellulose fibers may also be used.

As the fabric, for example, it is possible to use various kinds of fabrics such as plain weave, twill weave, satin, varied plain weave, varied twill weave, varied satin, varied weave, patterned weave, single layer weave, double weave, multiple weaves, warp pile weave, weft pile weave, intertwined weave, and the like.

In addition, it is possible to set the thickness of the fibers forming the fabric, for example, to 10d or more and 100d or less.

In addition, the fabric for this step may be subjected to a pre-process.

Examples of such pre-processes include acid processing, alkali processing, washing processing such as water rinsing, humidification processing, heating processing, and the like.

### 1-1-2. Carboxylic Anhydride-Containing Composition

In the attaching step, a carboxylic anhydride-containing composition containing a carboxylic anhydride is used.

The carboxylic anhydride-containing composition may be formed substantially only of carboxylic anhydride, or may include components other than carboxylic anhydride.

The carboxylic anhydride-containing composition may be in a solid form, such as a powder for example, but is preferably in a liquid form.

Due to this, it is possible to perform a process with higher uniformity with respect to the fabric and to more effectively prevent the occurrence of unwanted unevenness in the degree of processing in various parts of the fabric.

### 1-1-2-1. Carboxylic Anhydride

As the carboxylic anhydride forming the carboxylic anhydride-containing composition, for example, it is possible to use an aliphatic carboxylic anhydride, an aromatic carboxylic anhydride, and the like, but an aromatic carboxylic anhydride is preferable.

Due to this, it is possible for the affinity between the processed fabric obtained by the fabric processing method of the present disclosure and the dye to be superior and for the dyeability and color development to be superior. In particular, when a disperse dye is used as the dye, such effects are more remarkably exhibited.

In addition, as the carboxylic anhydride, for example, it is possible to use a carboxylic anhydride having a chemical structure in which a monovalent carboxylic acid is dehydrated and condensed between molecules, a carboxylic anhydride having a chemical structure in which a divalent carboxylic acid is dehydrated and condensed between molecules, and the like; however, it is preferable to use a carboxylic anhydride having a chemical structure in which a monovalent carboxylic acid is dehydrated and condensed between molecules.

Due to this, it is possible for the processed fabric obtained by the fabric processing method of the present disclosure to have higher hydrophobicity and for the affinity with the dye to be superior. As a result, it is possible for the dyeability and color development to be superior. In particular, when a disperse dye is used as the dye, such effects are more remarkably exhibited.

In addition, when the carboxylic anhydride has a chemical structure in which a monovalent carboxylic acid is dehydrated and condensed between molecules, the combination of the monovalent carboxylic acids is not particularly limited and may be the same carboxylic acid or may be different kinds of carboxylic acid.

The molecular weight of the carboxylic anhydride is not particularly limited, but is preferably 1000 or less, more preferably 100 or more and 800 or less, and even more preferably 200 or more and 500 or less.

Due to this, the steric hindrance of the carboxylic anhydride becomes smaller and it is possible for the reaction in the esterification step to proceed more suitably. As a result, it is possible for the productivity, dyeability with dyes, and color development of the processed fabric to be superior and for the fastness of the dyed product to also be superior.

The melting point of the carboxylic anhydride in a state of being a pure substance under 1 atm is not particularly limited, but is preferably −75° C. or higher and 100° C. or lower and more preferably −50° C. or higher and 80° C. or lower.

The boiling point of the carboxylic anhydride in a state of being a pure substance under 1 atm is not particularly limited, but is preferably 130° C. or higher and 390° C. or lower and more preferably 150° C. or higher and 360° C. or lower.

Specific examples of carboxylic anhydrides include acetic anhydride, propionic anhydride, butanoic anhydride, pentanoic anhydride, succinic anhydride, glutaric anhydride, adipic anhydride, maleic anhydride, phthalic anhydride, benzoic anhydride, bis(phenylacetic acid) anhydride, bis(phenylpropionic acid) anhydride, 1,8-naphthalene dicarboxylic anhydride, 1,4,5,8-naphthalene tetracarboxylic dianhydride, styrene-maleic anhydride copolymers, and the like and it is possible to use at least one selected from the above.

The content ratio of the carboxylic anhydride in the carboxylic anhydride-containing composition is preferably 10% by mass or more and 70% by mass or less and more preferably 20% by mass or more and 50% by mass or less.

Due to this, it is possible to make the ease of handling of the carboxylic anhydride-containing composition superior, to more suitably apply the carboxylic anhydride-containing composition to the fabric, and to also cause the esterification step to proceed more efficiently.

### 1-1-2-2. Solvent

The carboxylic anhydride-containing composition may be any composition which includes at least a carboxylic anhydride, but may also include a solvent which dissolves the carboxylic anhydride.

Due to this, it is possible to make the ease of handling and fluidity of the carboxylic anhydride-containing composition superior, to more effectively prevent unwanted variations in the amount of carboxylic anhydride attached to each part of the fabric, and to more suitably apply the carboxylic anhydride-containing composition to the fabric.

Examples of solvents include water; alcohol-based solvents such as methanol and ethanol; glycol ether solvents such as diethylene glycol methyl ethyl ether, diethylene glycol dimethyl ether, dipropylene glycol dimethyl ether, and diethylene glycol diethyl ether, and the like and it is possible to use one or two or more selected from the above in combination.

Among the above, as a solvent, at least one selected from the group consisting of water and alcohol-based solvents is preferable and a mixed solvent including water and ethanol is more preferable.

Due to this, it is possible to cause the desired reaction to proceed efficiently in the esterification step, while more effectively preventing unwanted reactions, such as the decomposition reaction of carboxylic anhydride in the carboxylic anhydride-containing composition, from proceeding, for example, during storage of the carboxylic anhydride-containing composition or the like. In addition, it is possible to more suitably perform the removal of solvent in the manufacturing process of the processed fabric.

The content ratio of the solvent in the carboxylic anhydride-containing composition is preferably 30% by mass or more and 100% by mass or less and more preferably 50% by mass or more and 90% by mass or less.

Due to this, while the carboxylic anhydride content ratio is sufficiently high, it is possible to make the ease of handling and fluidity of the carboxylic anhydride-containing composition superior, to more effectively prevent unwanted variations in the amount of carboxylic anhydride attached to each part of the fabric, and to more suitably apply the carboxylic anhydride-containing composition to the fabric. In addition, it is possible to cause the reaction in the esterification step to proceed more efficiently.

### 1-1-2-3. Other Components

The carboxylic anhydride-containing composition may include components other than described above. Such components are also referred to below as “other components” within this section.

Examples of other components include chelating agents, preservatives, fungicides, rust inhibitors, flame retardants, various dispersants, surfactants, antioxidants, UV absorbers, oxygen absorbers, dissolution aids, penetrating agents, and the like.

The content ratio of the other components in the carboxylic anhydride-containing composition is preferably 5.0% by mass or less and more preferably 1.0% by mass or less.

### 1-1-2-4. Others

The surface tension of the carboxylic anhydride-containing composition at 25° C. is not particularly limited, but is preferably 20 mN/m or more and 60 mN/m or less, more preferably 25 mN/m or more and 50 mN/m or less, and even more preferably 30 mN/m or more and 40 mN/m or less.

Due to this, it is possible for the affinity of the carboxylic anhydride-containing composition with respect to the fabric including the cellulose fibers to be more suitable and for unwanted variations in the amount of carboxylic anhydride attached to each part of the fabric to be more effectively suppressed.

As for the surface tension, it is possible to adopt a value measured by the Wilhelmy method or the ring method. For the measurement of the surface tension, it is possible to use a surface tension meter (for example, DY-300, DY-500, DY-700, and the like, manufactured by Kyowa Interface Science Co., Ltd.).

The viscosity of the carboxylic anhydride-containing composition at 25° C. is preferably 2 mPa·s or more and 100 mPa·s or less and more preferably 3 mPa·s or more and 50 mPa·s or less.

Due to this, it is possible to make the fluidity and ease of handling of the carboxylic anhydride-containing composition superior. In addition, it is possible for unwanted variations in the amount of carboxylic anhydride attached to each part of the fabric to be more effectively suppressed.

It is possible to determine the viscosity by measuring with an oscillating viscometer, a rotating viscometer, a thin tube viscometer, or a falling-ball viscometer. For example, with an oscillating viscometer, it is possible to carry out the determination by measurement in accordance with JIS 28809.

### 1-1-3. Processing Conditions

In this step, the carboxylic anhydride-containing composition may be applied to the entire fabric, or may be applied selectively to only a part thereof, but it is preferable to apply the carboxylic anhydride-containing composition to at least the entire part which is to be dyed.

In this step, the carboxylic anhydride-containing composition may be applied to the fabric by any method and examples of methods for applying a carboxylic anhydride-containing composition to a fabric include an immersion method, a spraying method, an ink jet method, and the like.

The temperature at which the carboxylic anhydride-containing composition is applied to the fabric in this step is preferably 10° C. or higher and 60° C. or lower and more preferably 20° C. or higher and 50° C. or lower.

In addition, in this step, for example, once an excess amount of the carboxylic anhydride-containing composition is applied to the fabric, a part of the applied carboxylic anhydride-containing composition may be removed from the fabric by pressing the fabric or the like to adjust the amount of carboxylic anhydride attached to the fabric.

Due to this, it is possible to more effectively suppress unwanted variations in the amount of carboxylic anhydride attached to each part of the fabric.

In addition, before the esterification step described in detail below, the fabric to which the carboxylic anhydride-containing composition is attached in the attaching step may be dried by air-drying or the like.

The reaction between the hydroxyl groups of the cellulose fibers and the carboxylic anhydride proceeds mainly in the esterification step described in detail below, but the reaction between the hydroxyl groups of the cellulose fibers and the carboxylic anhydride may also proceed in part in the attaching step.

### 1-2. Esterification Step

In the esterification step, the hydroxyl group of the cellulose forming the fabric to which the carboxylic anhydride was attached in the attaching step is esterified.

The temperature in the esterification step is preferably 20° C. or higher and 70° C. or lower and more preferably 25° C. or higher and 60° C. or lower.

Due to this, it is possible for the esterification reaction to proceed more suitably while more suitably preventing unwanted denaturation, degradation, and the like of the fabric or the carboxylic anhydride-containing composition attached to the fabric. In addition, it is possible for the productivity of the processed fabric to be superior.

The processing time in the esterification step is preferably 0.5 hours or more and 36 hours or less, more preferably 1 hour or more and 24 hours or less, and even more preferably 2 hours or more and 12 hours or less.

Due to this, it is possible to cause the esterification reaction to proceed sufficiently and for the quality of the dyed product manufactured using the obtained processed fabric to be superior. In addition, it is possible for the productivity of the processed fabric to be superior.

### 1-3. Decompression Drying Step

The fabric processing method of the present disclosure may further have, after the esterification step, a decompression drying step in which the fabric is decompressed and dried.

Due to this, it is possible to further promote the esterification reaction and further improve the quality of the dyed product manufactured using the obtained processed fabric.

The vacuum in the decompression drying step is preferably 1.0 kPa or less and more preferably 0.5 kPa or less.

The processing temperature in the decompression drying step is preferably 50° C. or higher and 150° C. or lower and more preferably 60° C. or higher and 100° C. or lower.

The processing time in the decompression drying step is preferably 5 minutes or more and 90 minutes or less and more preferably 15 minutes or more and 60 minutes or less.

### 1-4. Acid Processing Step

The fabric processing method of the present disclosure may further have, after the esterification step, an acid processing step in which the fabric is subjected to acid processing.

Due to this, it is possible to more effectively prevent the occurrence of unwanted yellowing of the processed fabric.

In this step, the composition used for the acid processing, that is, the acid processing composition, may be applied to the fabric by any method and examples of the method for applying the acid processing composition to the fabric include an immersion method, a spraying method, an ink jet method, and the like.

The processing temperature in this step is preferably 5° C. or higher and 50° C. or lower and more preferably 10° C. or higher and 40° C. or lower.

The processing time in this step is preferably 1 minute or more and 60 minutes or less, more preferably 3 minutes or more and 45 minutes or less, and even more preferably 5 minutes or more and 30 minutes or less.

### 1-4-1. Acid Processing Composition

A description will be given below of the composition used for the acid processing in this step, that is, the acid processing composition.

In the acid processing step, it is possible to suitably use an acid solution as the acid processing composition.

As the acid solution, an inorganic acid solution may be used or an organic acid solution may be used.

Examples of inorganic acids include hydrochloric acid, nitric acid, sulfuric acid, and the like.

Examples of organic acids include acetic acid, propionic acid, butanoic acid, pentanoic acid, succinic acid, glutaric acid, adipic acid, maleic acid, phthalic acid, benzoic acid, phenylacetic acid, phenylpropionic acid, malic acid, citric acid, adipic acid, lactic acid, N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyliminobisacetic acid (ADA), piperazine-1,4-bis(2-ethanesulfonic acid) (PIPES), N-(2-acetamido)-2-aminoethanesulfonic acid (ACES), coramine hydrochloride, N-tris(hydroxymethyl)methyl-2-aminoethanesulfonic acid (TES), and the like.

In particular, the acid processing step is preferably performed using a solution including hydrogen peroxide and acetic acid as the acid processing composition.

Due to this, it is possible to more effectively prevent the occurrence of unwanted yellowing of the processed fabric.

In the acid processing step, when a solution including hydrogen peroxide and acetic acid is used as the acid processing composition, the content ratio of hydrogen peroxide in the solution is preferably 0.1% by mass or more and 10% by mass or less and more preferably 0.2% by mass or more and 3% by mass or less.

Due to this, it is possible to more effectively prevent the occurrence of unwanted yellowing of the processed fabric.

In the acid processing step, when a solution including hydrogen peroxide and acetic acid is used as the acid processing composition, the content ratio of acetic acid in the solution is preferably 0.2% by mass or more and 10% by mass or less and more preferably 0.3% by mass or more and 5% by mass or less.

Due to this, it is possible to more effectively prevent the occurrence of unwanted yellowing of the processed fabric.

The pH at 25° C. of the acid solution as the acid processing composition used in this step is preferably 3 or more and 7 or less and more preferably 4 or more and 7 or less.

Due to this, it is possible to more effectively prevent the occurrence of unwanted yellowing of the processed fabric.

In the fabric processing method of the present disclosure, it is preferable to esterify 10% or more of the hydroxyl group of the cellulose. In other words, the esterification ratio in the fabric processing method of the present disclosure is preferably 10% or more.

Due to this, it is possible for the dyeability of the dye and color development of the obtained processed fabric to be superior.

As described above, the esterification ratio in the fabric processing method of the present disclosure is preferably 10% or more, more preferably 20% or more, and even more preferably 30% or more.

Due to this, the effects described above are more remarkably exhibited.

In addition, the upper limit of the esterification ratio in the fabric processing method of the present disclosure is preferably 97%, more preferably 90%, and even more preferably 85%.

Due to this, it is possible to relax the processing conditions in the esterification step and, in addition, to shorten the processing time and to further increase the productivity of the processed fabric. In addition, it is possible to more effectively decrease the ratio of the carboxylic anhydride that does not contribute to the desired reaction in the fabric processing method of the present disclosure, that is, the ratio that remains unreacted or that is consumed in a non-desired reaction such as hydrolysis, and to suppress material waste.

It is possible to determine the esterification ratio, that is, the ratio of hydroxyl groups of the cellulose included in the fabric used as raw material that are esterified by carboxylic anhydride, from measurement by an infrared spectroscopy method.

### 2. Processed Fabric

The processed fabric of the present disclosure is obtained by the fabric processing method of the present disclosure as described above.

Due to this, it is possible to provide a processed fabric with improved dyeability of the dye and excellent color development. In addition, it is possible to suitably use such a processed fabric to manufacture dyed products that also have excellent fastness and dyed products with excellent texture.

The processed fabric of the present disclosure is used for the manufacturing of the dyed product described below and has excellent dye-affinity of the dye and color development, while also having excellent storage stability. Accordingly, even in a case of being stored for a long period of time or in a case of being stored in environments of a relatively high temperature or the like before being dyed, it is possible for the fabric to exhibit excellent dye-affinity and color development.

### 3. Textile Printing Method

Next, a description will be given of the textile printing method of the present disclosure.

### 3-1. First Method

The textile printing method of the present disclosure, that is, a method for manufacturing a dyed product, has an ink composition attaching step of applying an ink jet dye textile printing ink composition containing a dye and water to an intermediate transfer medium by an ink jet method to form an image, and a transfer step of heating the intermediate transfer medium and a processed fabric obtained by the fabric processing method of the present disclosure in a state where the intermediate transfer medium and the processed fabric face each other such that the image is transferred to the processed fabric.

Due to this, it is possible to provide a textile printing method which is able to manufacture dyed products with excellent color development, fastness, and texture.

### 3-1-1. Ink Composition Attaching Step

In the ink composition attaching step, an ink jet dye textile printing ink composition containing a dye and water is applied to the intermediate transfer medium by an ink jet method to form an image. A plurality of ink jet textile printing ink compositions, for example, a plurality of ink jet dye textile printing ink compositions, may be used to form the image.

As the ink jet method for ejecting the ink jet dye textile printing ink composition, any method may be used and examples thereof include a charge deflection method, a continuous method, on-demand methods such as a piezo method or a bubble jet (registered trademark) method, and the like.

Due to this, it is possible to more effectively prevent denaturation of the coloring material in the ink jet head and to make the ejection stability by the ink jet method superior.

As an intermediate transfer medium, for example, it is possible to use paper such as plain paper, a recording medium provided with an ink-receiving layer, for example, a recording medium termed as ink jet special paper, coated paper, and the like.

When the amount of dye attached to the processed fabric is X [% by mass] and the esterification ratio of the cellulose forming the processed fabric by the carboxylic anhydride, that is, the ratio of the hydroxyl group of the cellulose included in the fabric used as a raw material in the fabric processing method of the present disclosure to be esterified by the carboxylic anhydride, is Y [%], the following relationship is preferable. That is, the relationship 2.0≤(X/Y)×100≤30.0 is preferable, the relationship 2.1≤(X/Y)×100≤10.0 is more preferable, and the relationship 2.2≤(X/Y)×100≤7.0 is even more preferable.

Due to this, it is possible for the color development and fastness of the obtained dyed product to be superior.

A detailed description will be given below of the ink jet dye textile printing ink composition but the dye included in the ink jet dye textile printing ink composition is preferably at least one selected from the group consisting of C.I. Disperse Blue 359, C.I. Disperse Blue 360, C.I. Disperse Red 60, C.I. Disperse Yellow 54, C.I. Disperse Orange 25, C.I. Disperse Red 364, and C.I. Disperse Yellow 82.

Due to this, the effects of the present disclosure are more remarkably exhibited.

### 3-1-2. Transfer Step

In the transfer step, the intermediate transfer medium and a processed fabric obtained by the fabric processing method of the present disclosure are heated in a state where the intermediate transfer medium and the processed fabric face each other such that the image is transferred to the processed fabric.

The heating temperature in this step is not particularly limited, but is preferably 140° C. or higher and 200° C. or lower and more preferably 150° C. or higher and 190° C. or lower.

Due to this, it is possible to reduce the energy required for the transfer and to further improve the productivity of the dyed product. In addition, it is possible to further improve the color development and fastness of the obtained dyed product.

The heating time in this step depends on the heating temperature, but is preferably 20 seconds or more and 180 seconds or less and more preferably 30 seconds or more and 120 seconds or less.

Due to this, it is possible to reduce the energy required for the transfer and to further improve the productivity of the dyed product. In addition, it is possible to further improve the color development and fastness of the obtained dyed product.

In addition, this step may be performed by carrying out heating in a state where the surface of the intermediate transfer medium to which the ink jet dye textile printing ink composition is attached and the processed fabric face each other while being separated by a certain distance, or may be performed by heating in a state of being closely attached to the surface of the processed fabric; however, the step is preferably performed by carrying out heating in a state where the surface of the intermediate transfer medium to which the ink jet dye textile printing ink composition is attached and the surface of the processed fabric are closely attached.

Due to this, it is possible to reduce the energy required for the transfer and to further improve the productivity of the dyed product. In addition, it is possible to further improve the color development of the obtained dyed product.

The transfer step is preferably performed such that the amount of dye attached to the processed fabric is 1.0 g/m² or more and 3.5 g/m² or less, more preferably performed to be 1.2 g/m² or more and 3.0 g/m² or less, and even more preferably performed to be 1.4 g/m² or more and 2.2 g/m² or less.

Due to this, it is possible for the color development and fastness of the obtained dyed product to be superior.

### 3-2. Second Method

In addition, it is also possible to manufacture the dyed product according to the present disclosure using, for example, the following method.

That is, it is possible to suitably manufacture the dyed product according to the present disclosure using a method, that is, using the second method, having an ink composition attaching step in which an ink jet dye textile printing ink composition containing a dye and water is applied by an ink jet method to a processed fabric obtained by the fabric processing method of the present disclosure to form an image, and a fixing step of heating the processed fabric on which the image is formed to fix the image.

According to this method, there is no need to use an intermediate transfer medium, which is advantageous from the viewpoints of the productivity of dyed products, resource saving, and energy saving.

A description will be given below focusing on the differences from the first method and the same points as described in the first method will not be repeated.

The processing temperature in the fixing step is not particularly limited, but is preferably 140° C. or higher and 200° C. or lower and more preferably 150° C. or higher and 190° C. or lower.

Due to this, it is possible to more efficiently fix the dye while more effectively preventing unwanted denaturation, degradation, and the like of the processed fabric, constituent components of the ink jet dye textile printing ink composition, and the like.

The processing time of the fixing step is not particularly limited, but 20 seconds or more and 180 seconds or less is preferable and 30 seconds or more and 120 seconds or less is more preferable.

Due to this, it is possible for the productivity of the dyed product to be superior while the dyeability of the dye with respect to the processed fabric is superior.

Steam may be used in the fixing step.

### 4. Composition Set

Next, a description will be given of the composition set of the present disclosure.

The composition set of the present disclosure is provided with a carboxylic anhydride-containing composition including a carboxylic anhydride, and an ink jet dye textile printing ink composition containing a dye and water.

Due to this, it is possible to provide a composition set able to be suitably used for the manufacturing of dyed products having excellent color development, fastness, and texture.

Since the carboxylic anhydride-containing composition forming the composition set of the present disclosure was described in the above-described section 1-1-2, a description will be given below of the ink jet dye textile printing ink composition.

### 4-1. Ink Jet Dye Textile Printing Ink Composition

The ink jet dye textile printing ink composition forming the composition set of the present disclosure contains a dye and water. In particular, the ink jet dye textile printing ink composition forming the composition set of the present disclosure is used for manufacturing dyed products by being applied to the processed fabric according to the present disclosure.

In this specification, the ink jet dye textile printing ink composition refers to a composition ejected by the ink jet method and used for dyeing a fabric.

The ink jet dye textile printing ink composition may be directly applied to the processed fabric according to the present disclosure by the ink jet method, or may be indirectly applied to the processed fabric according to the present disclosure by being applied to an intermediate transfer medium by the ink jet method and then transferring an image formed on the intermediate transfer medium thereto.

### 4-1-1. Dye

The ink jet dye textile printing ink composition forming the composition set of the present disclosure includes a dye.

Examples of dyes include disperse dyes, acid dyes, basic dyes, direct dyes, reactive dyes, and the like.

The disperse dyes are not particularly limited and examples thereof include C.I. Disperse Yellow 3, 4, 5, 7, 9, 13, 23, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 160, 162, 163, 164, 165, 179, 180, 182, 183, 184, 186, 192, 198, 199, 202, 204, 210, 211, 215, 216, 218, 224, 227, 231, and 232; C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, and 142; C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328, and 364; C.I. Disperse Violet 1, 4, 8, 23, 26, 27, 28, 31, 33, 35, 36, 38, 40, 43, 46, 48, 50, 51, 52, 56, 57, 59, 61, 63, 69, and 77; C.I. Disperse Green 9, C.I. Disperse Brown 1, 2, 4, 9, 13, and 19; C.I. Disperse Blue 3, 7, 9, 14, 16, 19, 20, 26, 27, 35, 43, 44, 54, 55, 56, 58, 60, 62, 64, 71, 72, 73, 75, 79, 81, 82, 83, 87, 91, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333, 359, and 360; and C.I. Disperse Black 1, 3, 10, and 24.

The acid dyes are not particularly limited and examples thereof include C.I. Acid Yellow 1, 3, 6, 11, 17, 18, 19, 23, 25, 36, 38, 40, 40:1, 42, 44, 49, 59, 59:1, 61, 65, 67, 72, 73, 79, 99, 104, 159, 169, 176, 184, 193, 200, 204, 207, 215, 219, 219:1, 220, 230, 232, 235, 241, 242, and 246; C.I. Acid Orange 3, 7, 8, 10, 19, 22, 24, 33, 51, 51S, 56, 67, 74, 80, 86, 87, 88, 89, 94, 95, 107, 108, 116, 122, 127, 140, 142, 144, 149, 152, 156, 162, 166, and 168; C.I. Acid Red 1, 6, 8, 9, 13, 18, 27, 35, 37, 52, 54, 57, 60, 73, 82, 88, 97, 97:1, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, and 415; C.I. Acid Violet 17, 19, 21, 42, 43, 47, 48, 49, 54, 66, 78, 90, 97, 102, 109, and 126; C.I. Acid Blue 1, 7, 9, 15, 23, 25, 40, 61:1, 62, 72, 74, 80, 83, 90, 92, 103, 104, 112, 113, 114, 120, 127, 127:1, 128, 129, 138, 140, 142, 156, 158, 171, 182, 185, 193, 199, 201, 203, 204, 205, 207, 209, 220, 221, 224, 225, 229, 230, 239, 258, 260, 264, 277:1, 278, 279, 280, 284, 290, 296, 298, 300, 317, 324, 333, 335, 338, 342, and 350; C.I. Acid Green 9, 12, 16, 19, 20, 25, 27, 28, 40, 43, 56, 73, 81, 84, 104, 108, and 109; C.I. Acid Brown 2, 4, 13, 14, 19, 28, 44, 123, 224, 226, 227, 248, 282, 283, 289, 294, 297, 298, 301, 355, 357, and 413; C.I. Acid Black 1, 2, 3, 24, 24:1, 26, 31, 50, 52, 52:1, 58, 60, 63, 63S, 107, 109, 112, 119, 132, 140, 155, 172, 187, 188, 194, 207, 222, and the like.

The basic dyes are not particularly limited and examples thereof include C.I. Basic Yellow 1, 2, 13, 19, 21, 25, 32, 36, 40, and 51; C.I. Basic Red 1, 5, 12, 19, 22, 29, 37, 39, and 92; C.I. Basic Blue 1, 3, 9, 11, 16, 17, 24, 28, 41, 45, 54, 65, and 66; C.I. Basic Black 2, 8, and the like.

The direct dyes are not particularly limited and examples thereof include C.I. Direct Yellow 8, 9, 10, 11, 12, 22, 27, 28, 39, 44, 50, 58, 86, 87, 98, 105, 106, 130, 137, 142, 147, and 153; C.I. Direct Orange 6, 26, 27, 34, 39, 40, 46, 102, 105, 107, and 118; C.I. Direct Red 2, 4, 9, 23, 24, 31, 54, 62, 69, 79, 80, 81, 83, 84, 89, 95, 212, 224, 225, 226, 227, 239, 242, 243, and 254; C.I. Direct Violet 9, 35, 51, 66, 94, and 95; C.I. Direct Blue 1, 15, 71, 76, 77, 78, 80, 86, 87, 90, 98, 106, 108, 160, 168, 189, 192, 193, 199, 200, 201, 202, 203, 218, 225, 229, 237, 244, 248, 251, 270, 273, 274, 290, and 291; C.I. Direct Green 26, 28, 59, 80, and 85; C.I. Direct Brown 44, 44:1, 106, 115, 195, 209, 210, 212:1, 222, and 223; C.I. Direct Black 17, 19, 22, 32, 51, 62, 108, 112, 113, 117, 118, 132, 146, 154, 159, 169, and the like.

The reactive dyes are not particularly limited and examples thereof include C.I. Reactive Yellow 2, 3, 7, 15, 17, 18, 22, 23, 24, 25, 27, 37, 39, 42, 57, 69, 76, 81, 84, 85, 86, 87, 92, 95, 102, 105, 111, 125, 135, 136, 137, 142, 143, 145, 151, 160, 161, 165, 167, 168, 175, and 176; C.I. Reactive Orange 1, 4, 5, 7, 11, 12, 13, 15, 16, 20, 30, 35, 56, 64, 67, 69, 70, 72, 74, 82, 84, 86, 87, 91, 92, 93, 95, 99, and 107; C.I. Reactive Red 2, 3, 3:1, 5, 8, 11, 21, 22, 23, 24, 28, 29, 31, 33, 35, 43, 45, 49, 55, 56, 58, 65, 66, 78, 83, 84, 106, 111, 112, 113, 114, 116, 120, 123, 124, 128, 130, 136, 141, 147, 158, 159, 171, 174, 180, 183, 184, 187, 190, 193, 194, 195, 198, 218, 220, 222, 223, 226, 228, 235, and 245; C.I. Reactive Violet 1, 2, 4, 5, 6, 22, 23, 33, 36, and 38; C.I. Reactive Blue 2, 3, 4, 7, 13, 14, 15, 19, 21, 25, 27, 28, 29, 38, 39, 41, 49, 50, 52, 63, 69, 71, 72, 77, 79, 89, 104, 109, 112, 113, 114, 116, 119, 120, 122, 137, 140, 143, 147, 160, 161, 162, 163, 168, 171, 176, 182, 184, 191, 194, 195, 198, 203, 204, 207, 209, 211, 214, 220, 221, 222, 231, 235, and 236; C.I. Reactive Green 8, 12, 15, 19, and 21; C.I. Reactive Brown 2, 7, 9, 10, 11, 17, 18, 19, 21, 23, 31, 37, 43, and 46; C.I. Reactive Black 5, 8, 13, 14, 31, 34, 39, and the like.

Among the above, the dye included in the ink jet dye textile printing ink composition forming the composition set of the present disclosure is preferably a disperse dye.

Due to this, it is possible for the color development, fastness, and the like of the manufactured dyed product to be superior.

The content ratio of the coloring material in the ink jet dye textile printing ink composition is not particularly limited, but is preferably 0.8% by mass or more and 10.0% by mass or less and more preferably 1.0% by mass or more and 8.0% by mass or less.

Due to this, it is easier to secure sufficient color concentration in a recording section formed using the ink jet dye textile printing ink composition and it is also possible to make the ink jet dye textile printing ink composition have superior high temperature stability, storage stability, ejection stability, clogging recovery, and the like.

### 4-1-2. Water

The ink jet dye textile printing ink composition forming the composition set of the present disclosure includes water.

Water is a component which functions as a solvent to dissolve, or a dispersant to disperse, solid content such as dyes in the ink jet dye textile printing ink composition, for example.

As the water, pure water such as RO water, distilled water, ion exchange water, or the like may be used, for example.

The content ratio of the water in the ink jet dye textile printing ink composition is preferably 50.0% by mass or more and 98.0% by mass or less, more preferably 55.0% by mass or more and 95.0% by mass or less, and even more preferably 60.0% by mass or more and 92.0% by mass or less.

Due to this, it is possible to more reliably adjust the viscosity of the ink jet dye textile printing ink composition to a suitable value and to further improve the ejection stability by the ink jet method.

### 4-1-3. Water-Soluble Organic Solvent

The ink jet dye textile printing ink composition forming the composition set of the present disclosure may include a water-soluble organic solvent.

Due to this, it is possible to improve the moisture retention property of the ink jet dye textile printing ink composition and to more effectively prevent the solid content of the ink jet dye textile printing ink composition from unwantedly precipitating or the like due to drying or the like in the ink jet head or the like. In addition, it is possible to more suitably adjust the viscosity of the ink jet dye textile printing ink composition. As a result, it is possible for the ejection stability of the ink jet dye textile printing ink composition by the ink jet method to be superior.

The water-soluble organic solvent may be any organic solvent which exhibits solubility in water and, for example, it is possible to suitably use an organic solvent having a solubility in water of 10 g/100 g water or more at 20° C.

The boiling point of the water-soluble organic solvent at 1 atm is preferably 150° C. or higher and 350° C. or lower.

Due to this, it is possible to further improve the moisture retention property of the ink jet dye textile printing ink composition and to more effectively prevent the solid content of the ink jet dye textile printing ink composition from unwantedly precipitating or the like due to drying or the like in the ink jet head or the like. As a result, it is possible for the ejection stability of the ink jet dye textile printing ink composition by the ink jet method to be superior. In addition, after the ink jet dye textile printing ink composition is ejected, it is possible to carry out volatilization relatively easily when necessary and to effectively prevent the water-soluble organic solvent from unwantedly remaining in the dyed product to be manufactured.

Examples of such water-soluble organic solvents include alkyl monoalcohols, alkyl diols, glycerin, glycols, glycol monoethers, lactams, and the like and it is possible to use one or two or more selected from the above.

Examples of glycols include triethanolamine, ethylene glycol, diethylene glycol, triethylene glycol, propylene glycol, and the like. In addition, examples of glycol monoethers include triethylene glycol monomethyl ether, triethylene glycol monobutyl ether, and the like. In addition, examples of lactams include 2-pyrrolidone, 1-(2-hydroxyethyl)-2-pyrrolidone, and the like.

The content ratio of the water-soluble organic solvent in the ink jet dye textile printing ink composition is preferably 1.0% by mass or more and 50.0% by mass or less, more preferably 3.0% by mass or more and 45.0% by mass or less, and even more preferably 5.0% by mass or more and 40.0% by mass or less.

Due to this, it is possible to more reliably adjust the viscosity of the ink jet dye textile printing ink composition to a suitable value and to further improve the ejection stability by the ink jet method.

### 4-1-4. Surfactant

The ink jet dye textile printing ink composition forming the composition set of the present disclosure may include a surfactant.

Examples of the surfactant include various anionic surfactants, cationic surfactants, nonionic surfactants, and the like and it is possible to use one or two or more selected from the above.

The content ratio of the surfactant in the ink jet dye textile printing ink composition is preferably 0.03% by mass or more and 2.5% by mass or less, more preferably 0.05% by mass or more and 2.0% by mass or less, and even more preferably 0.1% by mass or more and 1.5% by mass or less.

### 4-1-5. Resin Material

The ink jet dye textile printing ink composition forming the composition set of the present disclosure may include a resin material.

Due to this, for example, when a dyed product is manufactured by the second method as described below, it is possible for the fixation of the recording section by the dye and fastness of the dyed product to be superior.

As the resin material, for example, it is possible to use a polyester resin, a urethane-based resin, an acrylstyrene copolymer resin, or the like.

When the ink jet dye textile printing ink composition includes a resin material, the content ratio of the resin material in the ink jet dye textile printing ink composition is preferably 0.1% by mass or more and 15.0% by mass or less, more preferably 0.5% by mass or more and 10.0% by mass or less, and even more preferably 0.5% by mass or more and 8.0% by mass or less.

Due to this, it is possible for the fastness of the dyed product to be superior while having a sufficiently excellent texture of the finally obtained dyed product.

### 4-1-6. Other Components

The ink jet dye textile printing ink composition forming the composition set of the present disclosure may include components other than the components described above. Such components are also referred to below as “other components” in this section.

Examples of other components include chelating agents, preservatives, fungicides, rust inhibitors, flame retardants, various dispersants, antioxidants; UV absorbers, oxygen absorbers, dissolution aids, penetrating agents, and the like.

Examples of chelating agents include ethylenediaminetetraacetic acid salts and the like. In addition, examples of preservatives and fungicides include sodium benzoate, sodium pentachlorophenol, sodium 2-pyridine thiol-1-oxide, sodium sorbate, sodium dehydroacetate, 1,2-dibenzoisothiazolin-3-one, 4-chloro-3-methylphenol, and the like. In addition, examples of rust inhibitors include benzotriazole and the like.

The content ratio of the other components is preferably 5.0% by mass or less, and 1.0% by mass or less is more preferable.

### 4-1-7. Others

The surface tension of the ink jet dye textile printing ink composition forming the composition set of the present disclosure at 25° C. is not particularly limited, but is preferably 20 mN/m or more and 60 mN/m or less, more preferably 25 mN/m or more and 50 mN/m or less, and even more preferably 30 mN/m or more and 40 mN/m or less.

Due to this, it is more difficult for clogging or the like to occur in the nozzles of the ink jet head and the ejection stability of the ink jet dye textile printing ink composition is further improved. In addition, even when nozzle clogging occurs, it is possible for the recovery by capping the nozzles to be superior.

The viscosity at 25° C. of the ink jet dye textile printing ink composition forming the composition set of the present disclosure is preferably 2 mPa·s or more and 10 mPa·s or less and more preferably 3 mPa·s or more and 8 mPa·s or less.

Due to this, the ejection stability of the ink jet dye textile printing ink composition by the ink jet method is superior.

### 4-2. Others

The composition set of the present disclosure may be provided with at least one carboxylic anhydride-containing composition and the ink jet dye textile printing ink composition, respectively. In other words, the composition set of the present disclosure may be provided with a plurality of the carboxylic anhydride-containing compositions according to the present disclosure and may be provided with a plurality of ink jet dye textile printing ink compositions.

The composition set of the present disclosure is preferably provided with three ink jet dye textile printing ink compositions corresponding to three primary colors, that is, cyan, magenta, and yellow. The three primary colors may be more finely divided according to the color concentrations thereof. For example, in addition to cyan, magenta, and yellow, light cyan, light magenta, and light yellow may be provided.

The composition set of the present disclosure may also be provided with an achromatic ink jet dye textile printing ink composition, more specifically, a black ink.

In addition, the composition set of the present disclosure may be provided with other compositions, in addition to the carboxylic anhydride-containing composition and the ink jet dye textile printing ink composition.

Examples of such compositions include acid processing compositions or the like able to be used in the acid processing step as described above.

When the composition set of the present disclosure is provided with an acid processing composition, the composition set of the present disclosure may be provided with a plurality of acid processing compositions.

Acid processing compositions were described in the above-described section 1-4-1 and thus description thereof will not be repeated here.

Although suitable embodiments of the present disclosure were described above, the present disclosure is not limited thereto.

For example, the fabric processing method and textile printing method of the present disclosure may have steps other than the steps described above, as necessary.

More specifically, for example, the fabric processing method of the present disclosure may have a washing step between the esterification step and the acid processing step.

In addition, the method may also have a washing step and a drying step after the acid processing step.

It is possible to perform the washing step, for example, by organic solvent washing using an organic solvent such as isopropanol, or by water rinsing.

### EXAMPLES

Next, a description will be given of specific Examples of the present disclosure.

### 5. Preparation of Carboxylic Anhydride-Containing Composition

### Preparation Examples A1 to A6

Carboxylic anhydride-containing compositions were prepared by mixing a predetermined carboxylic anhydride and a solvent in a predetermined ratio.

The compositions of the carboxylic anhydride-containing compositions of the above Preparation Examples A1 to A6 are summarized in Table 1. The surface tension at 25° C. of the carboxylic anhydride-containing compositions of Preparation Examples A1 to A6, measured by the Wilhelmy method, were all values in a range of 30 mN/m or more and 40 mN/m or less. In addition, the viscosities at 25° C. of the carboxylic anhydride-containing compositions of Preparation Examples A1 to A6, measured in accordance with JIS Z8809 using an oscillating viscometer, were all values in a range of 3 mPa·s or more and 50 mPa·s or less.

TABLE 1

| | Carboxylic anhydride | | Solvent | |
|---|---|---|---|---|
| | Type | Content ratio (% by mass) | Type | Content ratio (% by mass) |
| Preparation Example A1 | Propionic anhydride | 30 | Ethanol | 70 |
| Preparation Example A2 | Butanoic anhydride | 20 | Ethanol | 80 |
| Preparation Example A3 | 1,8-naphthalene dicarboxylic anhydride | 20 | Diethylene glycol diethyl ether | 80 |
| Preparation Example A4 | Phthalic anhydride | 20 | Water | 80 |
| Preparation Example A5 | 1,4,5,8-naphthalene tetracarboxylic dianhydride | 10 | Diethylene glycol diethyl ether | 90 |
| Preparation Example A6 | Styrene-maleic anhydride copolymer (average molecular weight 1200) | 10 | Diethylene glycol diethyl ether | 90 |

### 6. Preparation of Ink Jet Dye Textile Printing Ink Compositions

### Preparation Examples B1 to B6

Ink jet dye textile printing ink compositions were prepared by mixing a predetermined dye, propylene glycol, glycerin, triethylene glycol monomethyl ether, and pure water in a predetermined ratio.

The compositions of the ink jet dye textile printing ink compositions of Preparation Examples B1 to B6 are summarized in Table 2. In the table, C.I. Disperse Blue 359 is referred to as “DB359,”, C.I. Disperse Red 60 is referred to as “DR60,”, C.I. Disperse Yellow 54 is referred to as “DY54,”, propylene glycol is referred to as “PG”, glycerin is referred to as “GL”, triethylene glycol monomethyl ether is referred to as “TEGMME”, and BYK-348 (manufactured by BYK) as surfactant is referred to as “BYK 348”. In addition, the surface tensions at 25° C. of the ink jet dye textile printing ink compositions of Preparation Examples B1 to B6 measured by the Wilhelmy method were all values in a range of 30 mN/m or more and 40 mN/m or less. In addition, the viscosities at 25° C. of the ink jet dye textile printing ink compositions of Preparation Examples B1 to B6 measured in accordance with JIS Z8809 using an oscillating viscometer were all values in a range of 3 mPa·s or more and 8 mPa·s or less.

TABLE 2

| | Content ratio (% by mass) | | | | | | | |
|---|---|---|---|---|---|---|---|---|
| | | | | Water-soluble | | | | |
| | Dye | | | organic solvent | | | Surfactant | |
| | DB359 | DR60 | DY54 | PG | GL | TEGMME | BYK348 | Water |
| Preparation | 5.0 | — | — | 5.0 | 10.0 | 5.0 | 0.5 | 74.5 |
| Example B1 | | | | | | | | |
| Preparation | — | 5.0 | — | 5.0 | 10.0 | 5.0 | 0.5 | 74.5 |
| Example B2 | | | | | | | | |
| Preparation | — | — | 5.0 | 5.0 | 10.0 | 5.0 | 0.5 | 74.5 |
| Example B3 | | | | | | | | |
| Preparation | 8.0 | — | — | 5.0 | 10.0 | 5.0 | 0.5 | 71.5 |
| Example B4 | | | | | | | | |
| Preparation | — | 8.0 | — | 5.0 | 10.0 | 5.0 | 0.5 | 71.5 |
| Example B5 | | | | | | | | |
| Preparation | — | — | 8.0 | 5.0 | 10.0 | 5.0 | 0.5 | 71.5 |
| Example B6 | | | | | | | | |

### 7. Preparation of Acid Processing Composition

### Preparation Example C1

An acid processing composition with a hydrogen peroxide content ratio of 3% by mass was obtained by mixing a 30 W/V % hydrogen peroxide solution (manufactured by Tokyo Chemical Industry Co., Ltd.) and pure water. The pH of the acid processing composition at 25° C. was 6.5.

### 8. Manufacturing of Processed Fabric and Manufacturing of Dyed Product

### Example 1

First, the carboxylic anhydride-containing composition of Preparation Example A1, the three ink jet dye textile printing ink compositions of Preparation Examples B1 to B3, and the acid processing composition of Preparation Example C1 were combined to form a composition set.

Next, a cotton broadcloth (#4000) manufactured by Nisshinbo Chemical Inc., was prepared as a fabric and the attaching step was performed to attach the carboxylic anhydride to the fabric containing cellulose by immersion in the carboxylic anhydride-containing composition of Preparation Example A1 at 50° C.

The esterification step was performed to esterify the hydroxyl group of the cellulose forming the fabric by holding a state in which the fabric was immersed in the carboxylic anhydride-containing composition for 3 hours.

Next, the fabric was taken out from the carboxylic anhydride-containing composition, which was the immersion solution, and squeezed with a mangle roller, followed by air-drying for 6 hours.

Next, the decompression drying step was performed by decompressing and drying in a vacuum of 0.5 kPa and at a temperature of 70° C. for 30 minutes.

Next, the acid processing step was performed by immersion in the acid processing composition of Preparation Example C1 at 25° C. for 10 minutes.

Next, the fabric was taken out from the acid processing composition, which was the immersion solution, subjected to water rinsing, and squeezed with a mangle roller, followed by air-drying for 6 hours to obtain the processed fabric. The esterification ratio of the processed fabric obtained in this manner was 30%.

The processed fabric obtained as described above was used to manufacture a dyed product by the following method using an intermediate transfer medium.

First, ink cartridges accommodating the ink jet dye textile printing ink compositions of Preparation Examples B1 to B3 were mounted on an ink jet printer (PX-G930 manufactured by Seiko Epson Corporation).

Next, the three ink jet dye textile printing ink compositions described above were ejected from this ink jet printer by the ink jet method onto a surface provided with a coated layer of coated paper (Transjet Sportsline 1254, manufactured by Cham Paper Group AG) as the intermediate transfer medium and an image was formed having three regions to which the three ink jet dye textile printing ink compositions were respectively applied without overlapping each other. All of the three regions described above were made into a filled pattern with conditions of a resolution of 720 dpi horizontally and 720 dpi vertically, 100% duty, and an amount of dye attached to the processed fabric of 1.75 g/m².

The intermediate transfer medium described above on which the image was formed and the processed fabric manufactured as described above were made to face each other and heated and pressed at a temperature of 180° C. for 40 seconds with 4.2 N/cm³ pressure using a heat pressing machine (TP-608M, manufactured by Taiyo Seiki Co., Ltd.) to heat-transfer the image formed on the intermediate transfer medium to the processed fabric and obtain a dyed product evaluation sample. At this time, the intermediate transfer medium was arranged such that the surface on which the image was formed was facing the processed fabric.

### Examples 2 to 15

Processed fabrics and dyed products were manufactured in the same manner as in Example 1 above, respectively, except that, in the process of manufacturing the processed fabric, that is, in the process of the fabric processing method, the conditions of the esterification step were as shown in Table 3 and the presence or absence of the decompression drying step and the acid processing step were as shown in Table 3 and, in the process of manufacturing the dyed product, that is, in the process of the textile printing method, the conditions of the kinds of the ink jet dye textile printing ink composition and the amount of dye attached were as shown in Table 3.

### Comparative Example 1

A dyed product was manufactured in the same manner as in Example 1 above, except that instead of the processed fabric, a cotton broadcloth (#4000) manufactured by Nisshinbo Chemical Inc., which was not subjected to processing with a carboxylic anhydride, was used.

### Example 16

A dyed product was manufactured in the same manner as in Example 1 above, except that, instead of the method using the intermediate transfer medium after the processed fabric was manufactured in the same manner as in Example 1 above, a method was adopted in which the ink jet dye textile printing ink composition was directly ejected onto the processed fabric and heat pressed.

The heat pressing was performed using a heat pressing machine (TP-608M, manufactured by Taiyo Seiki Co., Ltd.) under heat pressing conditions where the temperature was 180° C. at a pressure of 4.2 N/cm³ for 40 seconds.

### Examples 17 to 30

Processed fabrics and dyed products were manufactured in the same manner as in Example 16 above respectively, except that, in the process of manufacturing the processed fabric, that is, in the process of the fabric processing method, the conditions of the esterification step were as shown in Table 4 and the presence or absence of the decompression drying step and the acid processing step were as shown in Table 4 and, in the process of manufacturing the dyed product, that is, in the process of the textile printing method, the conditions of the kinds of the ink jet dye textile printing ink composition and the amount of dye attached were as shown in Table 4.

### Comparative Example 2

A dyed product was manufactured in the same manner as in Example 16 above, except that, instead of the processed fabric, a cotton broadcloth (#4000) manufactured by Nisshinbo Chemical Inc., which was not subjected to processing with a carboxylic anhydride, was used.

### Example 31

A dyed product was manufactured in the same manner as in Example 1 above, except that, instead of the method using the intermediate transfer medium after the processed fabric was manufactured in the same manner as in Example 1 above, a method was adopted in which the ink jet dye textile printing ink composition was directly ejected onto the processed fabric and the dye was fixed by a steam method using superheated steam.

To fix the dye by the steam method, a steamer DHe type (manufactured by Mathis) was used and the process was performed under conditions of 180° C. for 40 seconds.

### Examples 32 to 45

Processed fabrics and dyed products were manufactured in the same manner as in Example 31 above respectively, except that, in the process of manufacturing the processed fabric, that is, in the process of the fabric processing method, the conditions of the esterification step were as shown in Table 5 and the presence or absence of the decompression drying step and the acid processing step were as shown in Table 5 and, in the process of manufacturing the dyed product, that is, in the process of the textile printing method, the conditions of the kinds of the ink jet dye textile printing ink composition, the amount of dye attached, and the heating time were as shown in Table 5.

### Comparative Example 3

Dyed products were manufactured in the same manner as in Example 31 above, except that, instead of the processed fabric, a cotton broadcloth (#4000) manufactured by Nisshinbo Chemical Inc., which was not subjected to processing with a carboxylic anhydride, was used and the heating time in the fixing step was changed.

The processing conditions in each of the Examples and each of the Comparative Examples are summarized in Table 3 to Table 5. Table 3 to Table 5 also show the values of (X/Y)×100, when the amount of dye attached to the fabric is X [g/m²] and the esterification ratio of the cellulose forming the processed fabric by the carboxylic anhydride is Y [%].

TABLE 3

| | | | | | | | Textile printing method | | | | |
|---|---|---|---|---|---|---|---|---|---|---|---|
| | Fabric processing method | | | | | | Ink composition attaching step | | | | |
| | Attaching | | | | | | | Amount | | | |
| | step | | | | | | | of dye | | | |
| | Carboxylic | Esterification step | | Decom- | | | Ink jet dye | attached | | Transfer step | |
| | anhydride- | Reaction | Reaction | pression | Acid | | textile | to | | Heating | Heating |
| | containing | temperature | time | drying | processing | Esterification | printing ink | fabric X | (X/Y) × | temperature | time |
| | composition | [° C.] | [hours] | step | step | ratio Y [%] | composition | [g/m²] | 100 | [° C.] | [seconds] |
| Example 1 | Preparation | 50 | 3 | Yes | Yes | 30 | Preparation | 1.75 | 5.83 | 180 | 40 |
| | Example A1 | | | | | | Examples | | | | |
| | | | | | | | B1, B2, B3 | | | | |
| Example 2 | Preparation | 25 | 3 | No | No | 30 | Preparation | 1.75 | 5.83 | 180 | 40 |
| | Example A1 | | | | | | Examples | | | | |
| | | | | | | | B1, B2, B3 | | | | |
| Example 3 | Preparation | 25 | 8 | No | No | 50 | Preparation | 1.75 | 3.50 | 180 | 40 |
| | Example A1 | | | | | | Examples | | | | |
| | | | | | | | B1, B2, B3 | | | | |
| Example 4 | Preparation | 25 | 24 | No | No | 80 | Preparation | 1.75 | 2.19 | 180 | 40 |
| | Example A1 | | | | | | Examples | | | | |
| | | | | | | | B1, B2, B3 | | | | |
| Example 5 | Preparation | 25 | 3 | No | No | 30 | Preparation | 2.8 | 9.33 | 180 | 40 |
| | Example A1 | | | | | | Examples | | | | |
| | | | | | | | B4, B5, B6 | | | | |
| Example 6 | Preparation | 25 | 8 | No | No | 50 | Preparation | 2.8 | 5.60 | 180 | 40 |
| | Example A1 | | | | | | Examples | | | | |
| | | | | | | | B4, B5, B6 | | | | |
| Example 7 | Preparation | 25 | 24 | No | No | 80 | Preparation | 2.8 | 3.50 | 180 | 40 |
| | Example A1 | | | | | | Examples | | | | |
| | | | | | | | B4, B5, B6 | | | | |
| Example 8 | Preparation | 25 | 3 | No | No | 50 | Preparation | 1.75 | 3.50 | 180 | 40 |
| | Example A2 | | | | | | Examples | | | | |
| | | | | | | | B1, B2, B3 | | | | |
| Example 9 | Preparation | 25 | 3 | No | No | 30 | Preparation | 1.75 | 5.83 | 180 | 40 |
| | Example A3 | | | | | | Examples | | | | |
| | | | | | | | B1, B2, B3 | | | | |
| Example 10 | Preparation | 25 | 3 | No | No | 30 | Preparation | 1.75 | 5.83 | 180 | 40 |
| | Example A4 | | | | | | Examples | | | | |
| | | | | | | | B1, B2, B3 | | | | |
| Example 11 | Preparation | 25 | 3 | No | No | 30 | Preparation | 1.75 | 5.83 | 180 | 40 |
| | Example A5 | | | | | | Examples | | | | |
| | | | | | | | B1, B2, B3 | | | | |
| Example 12 | Preparation | 50 | 3 | No | No | 55 | Preparation | 1.75 | 3.18 | 180 | 40 |
| | Example A1 | | | | | | Examples | | | | |
| | | | | | | | B1, B2, B3 | | | | |
| Example 13 | Preparation | 50 | 3 | Yes | No | 80 | Preparation | 1.75 | 2.19 | 180 | 40 |
| | Example A1 | | | | | | Examples | | | | |
| | | | | | | | B1, B2, B3 | | | | |
| Example 14 | Preparation | 25 | 3 | No | Yes | 30 | Preparation | 1.75 | 5.83 | 180 | 40 |
| | Example A1 | | | | | | Examples | | | | |
| | | | | | | | B1, B2, B3 | | | | |
| Example 15 | Preparation | 25 | 3 | No | No | 30 | Preparation | 1.75 | 5.83 | 180 | 40 |
| | Example A6 | | | | | | Examples | | | | |
| | | | | | | | B1, B2, B3 | | | | |
| Comparative | — | — | — | No | No | 0 | Preparation | 1.75 | 0 | 180 | 40 |
| Example 1 | | | | | | | Examples | | | | |
| | | | | | | | B1, B2, B3 | | | | |

TABLE 4

| | Fabric processing method | | | | | |
|---|---|---|---|---|---|---|
| | | Esterification step | | | | |
| | Attaching step | Reaction | Reaction | | Acid | |
| | Carboxylic anhydride- | temperature | time | Decompression | processing | Esterification |
| | containing composition | [° C.] | [hours] | drying step | step | ratio Y [%] |
| Example 16 | Preparation Example A1 | 50 | 3 | Yes | Yes | 30 |
| Example 17 | Preparation Example A1 | 25 | 3 | No | No | 30 |
| Example 18 | Preparation Example A1 | 25 | 8 | No | No | 50 |
| Example 19 | Preparation Example A1 | 25 | 24 | No | No | 80 |
| Example 20 | Preparation Example A1 | 25 | 3 | No | No | 30 |
| Example 21 | Preparation Example A1 | 25 | 8 | No | No | 50 |
| Example 22 | Preparation Example A1 | 25 | 24 | No | No | 80 |
| Example 23 | Preparation Example A2 | 25 | 3 | No | No | 50 |
| Example 24 | Preparation Example A3 | 25 | 3 | No | No | 30 |
| Example 25 | Preparation Example A4 | 25 | 3 | No | No | 30 |
| Example 26 | Preparation Example A5 | 25 | 3 | No | No | 30 |
| Example 27 | Preparation Example A1 | 50 | 3 | No | No | 55 |
| Example 28 | Preparation Example A1 | 50 | 3 | Yes | No | 80 |
| Example 29 | Preparation Example A1 | 25 | 3 | No | Yes | 30 |
| Example 30 | Preparation Example A6 | 25 | 3 | No | No | 30 |
| Comparative | — | — | — | No | No | 0 |
| Example 2 | | | | | | |

| | Textile printing method | | | | |
|---|---|---|---|---|---|
| | Ink composition attaching step | | | Fixing step | |
| | | Amount of dye | | Heating | Heating |
| | Ink jet dye textile printing ink | attached to | | temperature | time |
| | composition | fabric X [g/m²] | (X/Y) × 100 | [° C.] | [seconds] |
| Example 16 | Preparation Examples B1, B2, B3 | 1.75 | 5.83 | 180 | 40 |
| Example 17 | Preparation Examples B1, B2, B3 | 1.75 | 5.83 | 180 | 40 |
| Example 18 | Preparation Examples B1, B2, B3 | 1.75 | 3.50 | 180 | 40 |
| Example 19 | Preparation Examples B1, B2, B3 | 1.75 | 2.19 | 180 | 40 |
| Example 20 | Preparation Examples B4, B5, B6 | 2.8 | 9.33 | 180 | 40 |
| Example 21 | Preparation Examples B4, B5, B6 | 2.8 | 5.60 | 180 | 40 |
| Example 22 | Preparation Examples B4, B5, B6 | 2.8 | 3.50 | 180 | 40 |
| Example 23 | Preparation Examples B1, B2, B3 | 1.75 | 3.50 | 180 | 40 |
| Example 24 | Preparation Examples B1, B2, B3 | 1.75 | 5.83 | 180 | 40 |
| Example 25 | Preparation Examples B1, B2, B3 | 1.75 | 5.83 | 180 | 40 |
| Example 26 | Preparation Examples B1, B2, B3 | 1.75 | 5.83 | 180 | 40 |
| Example 27 | Preparation Examples B1, B2, B3 | 1.75 | 3.18 | 180 | 40 |
| Example 28 | Preparation Examples B1, B2, B3 | 1.75 | 2.19 | 180 | 40 |
| Example 29 | Preparation Examples B1, B2, B3 | 1.75 | 5.83 | 180 | 40 |
| Example 30 | Preparation Examples B1, B2, B3 | 1.75 | 5.83 | 180 | 40 |
| Comparative | Preparation Examples B1, B2, B3 | 1.75 | 0 | 180 | 40 |
| Example 2 | | | | | |

TABLE 5

| | Fabric processing method | | | | | | Textile printing method | | | | |
|---|---|---|---|---|---|---|---|---|---|---|---|
| | | Esterification | | | | | Ink composition attaching step | | | | |
| | | step | | | | | | Amount | | | |
| | Attaching step | Reac- | | | | | | of dye | | Fixing step | |
| | Carboxylic | tion | Reac- | Decom- | Acid | Ester- | Ink jet | attached | | Heating | |
| | anhydride- | temp- | tion | pression | pro- | ification | dye textile | to fabric | | temp- | Heating |
| | containing | erature | time | drying | cessing | ratio | printing ink | X | (X/Y) × | erature | time |
| | composition | [° C.] | [hours] | step | step | Y [%] | composition | [g/m²] | 100 | [° C.] | [seconds] |
| Example 31 | Preparation | 50 | 3 | Yes | Yes | 30 | Preparation Examples | 1.75 | 5.83 | 180 | 40 |
| | Example A1 | | | | | | B1,B2,B3 | | | | |
| Example 32 | Preparation | 25 | 3 | No | No | 30 | Preparation Examples | 1.75 | 5.83 | 180 | 120 |
| | Example A1 | | | | | | B1,B2,B3 | | | | |
| Example 33 | Preparation | 25 | 8 | No | No | 50 | Preparation Examples | 1.75 | 3.50 | 180 | 120 |
| | Example A1 | | | | | | B1,B2,B3 | | | | |
| Example 34 | Preparation | 25 | 24 | No | No | 80 | Preparation Examples | 1.75 | 2.19 | 180 | 120 |
| | Example A1 | | | | | | B1,B2,B3 | | | | |
| Example 35 | Preparation | 25 | 3 | No | No | 30 | Preparation Examples | 2.8 | 9.33 | 180 | 120 |
| | Example A1 | | | | | | B4,B5,B6 | | | | |
| Example 36 | Preparation | 25 | 8 | No | No | 50 | Preparation Examples | 2.8 | 5.60 | 180 | 120 |
| | Example A1 | | | | | | B4,B5,B6 | | | | |
| Example 37 | Preparation | 25 | 24 | No | No | 80 | Preparation Examples | 2.8 | 3.50 | 180 | 120 |
| | Example A1 | | | | | | B4,B5,B6 | | | | |
| Example 38 | Preparation | 25 | 3 | No | No | 50 | Preparation Examples | 1.75 | 3.50 | 180 | 120 |
| | Example A2 | | | | | | B1,B2,B3 | | | | |
| Example 39 | Preparation | 25 | 3 | No | No | 30 | Preparation Examples | 1.75 | 5.83 | 180 | 40 |
| | Example A3 | | | | | | B1,B2,B3 | | | | |
| Example 40 | Preparation | 25 | 3 | No | No | 30 | Preparation Examples | 1.75 | 5.83 | 180 | 40 |
| | Example A4 | | | | | | B1,B2,B3 | | | | |
| Example 41 | Preparation | 25 | 3 | No | No | 30 | Preparation Examples | 1.75 | 5.83 | 180 | 40 |
| | Example A5 | | | | | | B1,B2,B3 | | | | |
| Example 42 | Preparation | 50 | 3 | No | No | 55 | Preparation Examples | 1.75 | 3.18 | 180 | 40 |
| | Example A1 | | | | | | B1,B2,B3 | | | | |
| Example 43 | Preparation | 50 | 3 | Yes | No | 80 | Preparation Examples | 1.75 | 2.19 | 180 | 40 |
| | Example A1 | | | | | | B1,B2,B3 | | | | |
| Example 44 | Preparation | 25 | 3 | No | Yes | 30 | Preparation Examples | 1.75 | 5.83 | 180 | 40 |
| | Example A1 | | | | | | B1,B2,B3 | | | | |
| Example 45 | Preparation | 25 | 3 | No | No | 30 | Preparation Examples | 1.75 | 5.83 | 180 | 40 |
| | Example A6 | | | | | | B1,B2,B3 | | | | |
| Comparative | — | — | — | No | No | 0 | Preparation Examples | 1.75 | 0 | 180 | 120 |
| Example 3 | | | | | | | B1,B2,B3 | | | | |

### 9. Evaluation

### 9-1. Color Development

The dyed products according to each of the Examples and each of the Comparative Examples were evaluated for color development.

Specifically, for the recording sections of each color of each of the dyed products, OD values were determined from measurements using the FD-7 Spectrodensitometer (manufactured by Konica Minolta, Inc.), the ratio to the OD value of the recording section of the dyed product according to Comparative Example 1 was determined for Examples 1 to 15 and Comparative Example 1, the ratio to the OD value of the recording section of the dyed product according to Comparative Example 2 was determined for Examples 16 to 30 and Comparative Example 2, the ratio to the OD value of the recording section of the dyed product according to Comparative Example 3 was determined for Examples 31 to 45 and Comparative Example 3, and evaluation was carried out according to the following criteria. The higher the ratio, the better the color development. C or better was a good level.

A: OD value is 160% or more of that of the target Comparative Example.

B: OD value is 140% or more and less than 160% of that of the target Comparative Example.

C: OD value is 130% or more and less than 140% of that of the target Comparative Example.

D: OD value is less than 130% of that of the target Comparative Example.

### 9-2. Abrasion Resistance

The dyed products according to each of the Examples and each of the Comparative Examples were evaluated for abrasion resistance.

Specifically, each of the dyed products was left in conditions of 25° C. for one hour after manufacturing and, when the recording surface of the dyed product was rubbed 20 times with a cotton cloth under a load of 200 g using a GAKUSHIN-type Color Fastness Rubbing Tester AB-301 (manufactured by TESTER SANGYO CO., LTD.), the state of peeling of the recording surface and the state of ink transferring to the cotton cloth were visually confirmed and the abrasion resistance was evaluated according to the following criteria. The less color transferring and peeling, the better the abrasion resistance, and the better the abrasion resistance, the better the fastness. B or better was a good level, but even C was a usable level.

A: No color transferring or peeling is observed.

B: Slight color transferring and peeling is observed.

C: Color transferring and peeling is clearly observed.

### 9-3. Texture

The dyed products for each of the Examples and each of the Comparative Examples were evaluated for texture.

Specifically, for each recorded material, a sensory evaluation of the feel thereof was performed by a specific evaluator according to the following criteria and the texture was evaluated. The evaluation results mean that the texture is excellent in the order of C, B, and A.

A: Soft and no stiff feeling is observed.

B: Slightly hard and a slightly stiff feeling is observed.

C: There is a remarkably stiff feeling.

### 9-4. Resistance to Yellowing

The dyed products according to each of the Examples and each of the Comparative Examples were evaluated for the resistance to yellowing.

Specifically, white area portions of the dyed products according to each of the Examples and each of the Comparative Examples were visually observed and the resistance to yellowing was evaluated according to the following criteria. B or better was a good level, but even C was a usable level.

A: No yellowing of the material is observed.

B: Yellowing of the material is slightly observed.

C: Yellowing of the material is clearly observed.

These results are summarized Table 6 to Table 8.

TABLE 6

| | Color development | | | Abrasion | | Resistance |
|---|---|---|---|---|---|---|
| | Cyan | Magenta | Yellow | resistance | Texture | to yellowing |
| Example 1 | A | A | A | A | A | A |
| Example 2 | B | B | B | B | A | B |
| Example 3 | A | A | A | A | A | C |
| Example 4 | A | A | A | A | B | C |
| Example 5 | B | B | B | B | A | B |
| Example 6 | B | B | B | A | B | C |
| Example 7 | A | A | A | A | B | C |
| Example 8 | A | A | A | B | A | C |
| Example 9 | B | B | B | B | B | C |
| Example 10 | B | B | B | A | B | C |
| Example 11 | B | B | B | B | B | C |
| Example 12 | A | A | A | B | A | B |
| Example 13 | A | A | A | A | A | B |
| Example 14 | B | B | B | B | A | A |
| Example 15 | B | B | B | B | C | C |
| Comparative | D | D | D | B | A | A |
| Example 1 | | | | | | |

TABLE 7

| | | | | | | Resistance |
|---|---|---|---|---|---|---|
| | Color development | | | Abrasion | | to |
| | Cyan | Magenta | Yellow | resistance | Texture | yellowing |
| Example 16 | B | B | B | B | A | A |
| Example 17 | C | C | C | C | A | B |
| Example 18 | B | B | B | B | A | C |
| Example 19 | B | B | B | B | B | C |
| Example 20 | C | C | C | C | A | B |
| Example 21 | C | C | C | B | B | C |
| Example 22 | B | B | B | B | B | C |
| Example 23 | B | B | B | C | A | C |
| Example 24 | C | C | C | C | B | C |
| Example 25 | C | C | C | B | B | C |
| Example 26 | C | C | C | C | B | C |
| Example 27 | B | B | B | C | A | B |
| Example 28 | B | B | B | B | A | B |
| Example 29 | C | C | C | C | A | A |
| Example 30 | C | C | C | C | C | C |
| Comparative | D | D | D | C | A | A |
| Example 2 | | | | | | |

TABLE 8

| | Color | | | | | Resistance |
|---|---|---|---|---|---|---|
| | development | | | Abrasion | | to |
| | Cyan | Magenta | Yellow | resistance | Texture | yellowing |
| Example 31 | B | B | B | A | A | A |
| Example 32 | C | C | C | B | A | B |
| Example 33 | B | B | B | A | A | C |
| Example 34 | B | B | B | A | B | C |
| Example 35 | C | C | C | B | A | B |
| Example 36 | C | C | C | A | B | C |
| Example 37 | B | B | B | A | B | C |
| Example 38 | B | B | B | B | A | C |
| Example 39 | C | C | C | B | A | C |
| Example 40 | C | C | C | A | A | C |
| Example 41 | C | C | C | B | A | C |
| Example 42 | B | B | B | B | A | B |
| Example 43 | B | B | B | A | A | B |
| Example 44 | C | C | C | B | A | A |
| Example 45 | C | C | C | B | C | C |
| Comparative | D | D | D | C | B | A |
| Example 3 | | | | | | |

As is clear from Table 6 to Table 8, excellent results were obtained with the present disclosure. In contrast, satisfactory results were not obtained with the Comparative Examples.

In addition, dyed products were manufactured in the same manner as in the Examples and each of the Comparative Examples, except that #4700 (manufactured by Nisshinbo Chemical Inc.), T40 (manufactured by Nisshinbo Chemical Inc.), and P2816 (manufactured by Herdmans) were used as fabrics, and, when evaluated in the same manner as described above, the same results as described above were obtained.

In addition, dyed products were manufactured in the same manner as in the Examples and each of the Comparative Examples, except that, instead of the dyes described above, C.I. Disperse Blue 360, C.I. Disperse Orange 25, C.I. Disperse Red 364, and C.I. Disperse Yellow 82 were used as the dyes and, when evaluated in the same manner as described above, the same results as described above were obtained.

What is claimed is:

1. A fabric processing method comprising:
an attaching step of attaching a carboxylic anhydride to a fabric containing cellulose; and
an esterification step of esterifying a hydroxyl group of the cellulose, wherein, in the esterification step, carboxylic acid is introduced into the cellulose through an ester bond.

2. The fabric processing method according to claim 1, wherein a molecular weight of the carboxylic anhydride is 1000 or less.

3. The fabric processing method according to claim 1, wherein 10% or more of the hydroxyl group of the cellulose is esterified.

4. The fabric processing method according to claim 3, wherein 30% or more of the hydroxyl group of the cellulose is esterified.

5. The fabric processing method according to claim 1, wherein the esterification step is performed at a temperature of 20° C. or higher and 70° C. or lower.

6. The fabric processing method according to claim 1, further comprising:
a decompression drying step of decompressing and drying the fabric after the esterification step.

7. The fabric processing method according to claim 1, further comprising:
an acid processing step of carrying out acid processing after the esterification step.

8. The fabric processing method according to claim 7, wherein the acid processing step is performed using a solution including hydrogen peroxide and acetic acid.

9. A processed fabric obtained by the fabric processing method according to claim 1.

10. A textile printing method comprising:
an ink composition attaching step of applying an ink jet dye textile printing ink composition containing a dye and water to an intermediate transfer medium by an ink jet method to form an image; and
a transfer step of heating the intermediate transfer medium and a processed fabric obtained by the fabric processing method according to claim 1 in a state where the intermediate transfer medium and the processed fabric face each other such that the image is transferred to the processed fabric.

11. The textile printing method according to claim 10, wherein 2.0≤(X/Y)×100≤30.0, here an amount of the dye attached to the processed fabric is X [% by mass] and an esterification ratio of the cellulose forming the processed fabric by the carboxylic anhydride is Y [%].

12. The textile printing method according to claim 10, wherein the transfer step is performed such that an amount of dye attached to the processed fabric is 1.0 g/m² or more and 3.5 g/m² or less.

13. The textile printing method according to claim 10, wherein the dye is at least one selected from the group consisting of C.I. Disperse Blue 359, C.I. Disperse Blue 360, C.I. Disperse Red 60, C.I. Disperse Yellow 54, C.I. Disperse Orange 25, C.I. Disperse Red 364, and C.I. Disperse Yellow 82.

14. A composition set comprising:
a carboxylic anhydride-containing composition containing a carboxylic anhydride; and
an ink jet dye textile printing ink composition containing a dye and water.

15. The composition set according to claim 14, wherein the dye is a disperse dye.
